(19) United States
(12) Patent Application Publication
(10) Pub. No.: US 2013/0155405 A1
(43) Pub. Date: Jun. 20, 2013

(54) SPECTROPHOTOMETER

(71) Applicants: Toshiro Kimura, Kyoto (JP); Kazumi Yokota, Osaka (JP); Taro Osumi, Kyoto (JP)

(72) Inventors: Toshiro Kimura, Kyoto (JP); Kazumi Yokota, Osaka (JP); Taro Osumi, Kyoto (JP)

(73) Assignee: SHIMADZU CORPORATION, Koyoto-shi, Kyoto (JP)

(21) Appl. No.: 13/817,821

(22) PCT Filed: Aug. 11, 2011
(86) PCT No.: PCT/JP2011/068393

§ 371 Date: Feb. 19, 2013

(30) Foreign Application Priority Data
Aug. 18, 2010 (JP) 2010-183473

(51) Int. Cl. G01J 3/02; G01J 3/42

(52) U.S. Cl. CPC G01J 3/027; G01J 3/42
USPC 356/319

(57) ABSTRACT

In order to provide a spectrophotometer, which can detect, by means of output intensity signals obtained by a photodetector, the entry of external light at the time of sample cell replacement and the like without providing a door with an opening/closing sensor or the like, a spectrophotometer (60) is provided with: a photodetector (12); a light blocking unit (41); a storage unit (34), which stores a light blocking period where light is blocked by means of the light blocking unit (41) and output intensity signals obtained by the photodetector (12) by corresponding the light blocking periods to the output intensity signals; and a control unit (31b), which calculates transmittance or light absorbance on the basis of the output intensity signals in the light blocking periods, said output intensity signals having been stored in the storage unit (34), and output intensity signals in light entry periods. The spectrophotometer is characterized in that the storage unit (34) stores a threshold for detecting the entry of external light into the photodetector (12), and that the control unit (31c) detects the entry of the external light into the photodetector (12) on the basis of the output intensity signals in the light blocking periods, and the threshold.

### TECHNICAL FIELD

The present invention relates to a spectrophotometer where a photodetector detects light for measurement, and in particular, to a spectrophotometer using a photomultiplier tube of which the detection sensitivity (amplification factor) is variable in accordance with the voltage value applied from the outside as the photodetector.

### BACKGROUND ART

Double-beam type ultraviolet-visible spectrophotometers have been developed as apparatuses for measuring the transmittance of a sample (see Patent Document 1). FIG. 5 is a schematic diagram showing the structure of a double-beam type ultraviolet-visible spectrophotometer.

The ultraviolet-visible spectrophotometer 160 is provided with: a sample cell 6; a reference cell 8; a light source unit 50 having a light source 1 for emitting light for measurement and a spectrometer 2; a photodetector 12; a sector mirror (switching unit, light blocking unit) 40; a number of reflective mirrors 3, 5, 7, 9, 10 and 11; a housing 15 through which light does not transmit; a high voltage generating unit 22 for applying a voltage V to the photodetector 12; an index signal generating unit 20; an analog-digital (A/D) converter 14; a digital-analog (D/A) converter 21; and a computer 130 for controlling the entirety of the ultraviolet-visible spectrophotometer 160.

The sample cell 6, the reference cell 8, the light source unit 50, the photodetector 12, the sector mirror (switching unit, light blocking unit) 40 and the reflective mirrors 3, 5, 7, 9, 10 and 11 are placed in predetermined locations inside the housing 15.

In addition, the sample cell 6 and the reference cell 8 can be replaced with a new sample cell and a new reference cell when an analyzer opens the door 15a of the housing 15.

In the light source unit 50, light emitted from the light source 1 enters into the spectrometer 2 so that single color light (light for measurement) having a desired wavelength can be taken out by the spectrometer 2.

The sector mirror 40 separates the single color light to a sample side beam S and a reference side beam R alternately at a certain period of time. Furthermore, the sector mirror 40 is provided with the light blocking unit 41 that blocks the sample side beam S and the reference side beam R at a certain period of time as the sector mirror 40 rotates so that the light entry period of the sample side beam S, the light blocking period of the sample side beam S, the light entry period of the reference side beam R and the light blocking period of the reference side beam R are generated in this order at the certain period of time.

The index signal generating unit 20 syncs with the rotation of the sector mirror 40 that is driven to rotate at a predetermined speed and generates an index signal IDX, which consists of one pulse per rotation. The rotational period of the sector mirror 40 corresponds to a frequency that syncs with the frequency of the power supply, and 50 Hz or 60 Hz is adopted.

The computer 130 is provided with a CPU (control unit) 131 and a memory (storage unit) 134, and furthermore, an input apparatus 32 having a keyboard and a mouse and a display apparatus 33 are connected to the computer 130. In addition, the processes by the CPU 131 can be separated into blocks for description depending on the functions. The blocks are a storage control unit 31a for storing output intensity signals from the photodetector 12 in the memory 134, a calculation control unit 31b for calculating the transmittance, and a voltage control unit 131c for controlling the high voltage generating unit 22.

In the ultraviolet-visible spectrophotometer 160, light emitted from the light source 1 enters into the spectrometer 2 so that single color light having a desired wavelength is taken out by the spectrometer 2. The single color light is reflected from the reflective mirror 3 so as to be sent to the sector mirror 40 and is separated to the sample side beam S and the reference side beam R alternately by the sector mirror 40.

First, the sample side beam S is reflected from the reflective mirror 5 so as to be directed to the sample cell 6, and the light that has passed through the sample cell 6 is reflected from the reflective mirrors 9 and 11 so as to be sent to the light receiving surface of the photodetector 12. The light that has been sent to the photodetector 12 is subject to a photoelectric conversion in the photodetector 12 so as to be taken out as a sample side beam signal s. Here, the sector mirror 40 is provided with the light blocking unit 41 which blocks the sample side beam S at a certain period of time as the sector mirror 40 rotates, and therefore, the output intensity signal of the photodetector 12 that corresponds to the light blocking unit 41 is a sample side dark signal zₛ. In addition, the output intensity signal of the photodetector 12 is sampled by the A/D converter 14 at certain intervals of times so as to be converted to a digital voltage value (signal value).

Meanwhile, the reference side beam R is reflected from the reflective mirror 7 so as to be directed to the reference cell 8, and the light that has passed through the reference cell 8 is reflected from the reflective mirror 10 so as to be sent to the light receiving surface of the photodetector 12. The light that has been sent to the photodetector 12 is subject to a photoelectric conversion in the photodetector 12 so as to be taken out as a reference side beam signal r. Here, the sector mirror 40 is provided with the light blocking unit 41 which blocks the reference side beam R at a certain period of time as the sector mirror 40 rotates, and therefore, the output intensity signal of the photodetector 12 that corresponds to the light blocking unit 41 is a reference side dark signal zᵣ. In addition, the output intensity signal of the photodetector 12 is sampled by the A/D converter 14 at certain intervals of time so as to be converted to a digital voltage value (signal value).

The storage control unit 31a in the computer 130 carries out control so that the signal values from the photodetector 12 (sample side dark signal zs, sample side beam signal s, reference side dark signal zr and reference side beam signal r) are stored in the memory 134. At this time, the voltage V applied to the photodetector 12, the light blocking period during which the beam is blocked by the light blocking unit 41, the switching period during which the light path is switched by the sector mirror 40, and the output intensity signal obtained by the photodetector 12 are stored so that they correspond to each other.

FIG. 2 is a timing graph showing a period during which the sector mirror 40 rotates once (this is referred to as one period (n), and FIGS. 6(a) and 6(b) are graphs showing an example of the relationship between signal values (digital voltage values) over a number of periods of time and time.

During one period T, the photodetector 12 outputs the sample side beam signal s that corresponds to the light entry period of the sample side beam S, the sample side dark signal zₛ that corresponds to the light blocking period of the sample side beam S, the reference side beam signal r that corresponds to the light entry period of the reference side beam R, and the reference side dark signal zᵣ that corresponds to the light blocking period of the reference side beam R in this order.

In the case where the sampling period in the A/D converter 14 is short as compared to the period T in such a manner that a great number (six each in this example) of pieces of output data (hereinafter referred to as detection value data) of the A/D converter 14 can be obtained for each signal during the one period T, D1 to D6, D7 to D12, D13 to D18 and D19 to D24 are detection value data that respectively corresponds to the sample side beam signal s, the sample side dark signal zₛ, the reference side beam signal r and the reference side dark signal zᵣ.

The calculation control unit 31b uses the sample side beam signal s, the reference side beam signal r, the sample side dark signal zₛ and the reference side dark signal zᵣ that are thus stored in the memory 134 in order to carry out control in which the transmittance is calculated by means of the following formula (1):

transmittance (%)=[(s−zₛ)/(r−zᵣ)]×100 (1)

Typically, the average values of the detection value data D1 to D6 that corresponds to the sample side beam signal s, the detection value data D7 to D12 that corresponds to the sample side dark signal zₛ, the detection value data D13 to D18 that corresponds to the reference side beam signal r and the detection value data D19 to D24 that corresponds to the reference side dark signal zᵣ are respectively calculated for each period, and the results are substituted into the formula (1) so as to find the transmittance.

In the case where the light amount ratio is different between the sample side beam signal s and the reference side beam signal r, a coefficient is multiplied by the results of the formula (1) in order to correct the difference.

In general, ultraviolet-visible spectrophotometers, such as the ultraviolet-visible spectrophotometer 160, include a photomultiplier tube as the photodetector 12. When light enters through the entry window of a photomultiplier tube, it generates electrons in accordance with the amount of light that has entered due to the photoelectric effects and amplifies the number of electrons so as to output the results as a current. When a predetermined voltage V is applied to a photomultiplier tube, a current of which the amount is proportional to the amount of light that enters through the entry window is outputted, and thus, the amount of light that enters through the entry window can be determined from this output value.

At this time, the higher the amplification (applied voltage V) is, the greater the current value that is obtained as an amplification of the number of electrons in accordance with the amount of light that enters into the photomultiplier tube can be outputted, and therefore, detection with high sensitivity is possible in the photomultiplier tube. However, a problem of deterioration arises with the photomultiplier tube when the amount of outputted current exceeds the limit current value Iₜₕ.

Thus, the voltage control unit 131c carries out feedback control so as to determine the voltage V to be applied to the photodetector 12 in accordance with the signal value (output intensity signal) obtained in the photodetector (photomultiplier tube) 12, output an indication signal to the high voltage generating unit 22 in such a manner that the determined voltage V is applied, and adjust the detection sensitivity (amplification factor).

In addition, the high voltage generating unit 22 applies a predetermined voltage V to the photodetector 12 on the basis of the indication signal provided by the voltage control unit 131c through the D/A converter 21.

Therefore, in the ultraviolet-visible spectrophotometer 160, as shown in FIG. 6(a), the reference threshold I_{b} is stored in the memory 134 in advance, and the voltage control unit 131c compares the signal value (sample side beam signal s, reference side beam signal r) obtained in the photodetector 12 and the reference threshold I_{b} so as to reduce the current outputted from the photodetector 12 by lowering the voltage V applied to the photodetector 12, and thus by reducing the detection sensitivity when the signal value exceeds the reference threshold I_{b}, while increasing the current outputted from the photodetector 12 by increasing the voltage V applied to the photodetector 12, and thus by increasing the detection sensitivity when the signal value is less than the reference threshold I_{b}. That is to say, control is carried out so that the signal value (sample side beam signal s, reference side beam signal r) becomes the reference threshold I_{b}.

At this time, the voltage control unit 131c calculates the transmittance in the calculation control unit 31b using formula (1), and therefore, the voltage V applied to the photodetector 12 is maintained at a constant during one period T. That is to say, after the period T1 has been completed, the voltage control unit 131c determines the voltage V2 applied during the next period T2 so as to change the voltage V applied to the photodetector 12 from the voltage V1 to the voltage V2.

### PRIOR ART DOCUMENT

### Patent Document

Patent Document 1: Japanese Unexamined Patent Publication 2002-162294

### SUMMARY OF THE INVENTION

### Problem to Be Solved by the Invention

In the above-described ultraviolet-visible spectrophotometer 160, when the measurement of one sample has been finished and the measurement of the next sample begins, the door 15a of the housing 15 is opened in order to replace the sample cell 6 or the reference cell 8, and at this time, the photodetector 12 may deteriorate due to the entry of external light. That is to say, as shown in FIG. 6(b), when the door 15a of the housing 15 is opened, the output intensity signal (dotted line) exceeds the limit current value Iₜₕ, namely, the signal value (solid line) reaches the AD conversion limit value, and therefore, feedback control is to be carried out so as to lower the voltage V applied to the photodetector 12. One feedback control makes the applied voltage V lower to such a degree that the signal value changes from the AD conversion limit value to the reference threshold I_{b}, and therefore, the state where the output intensity signal exceeds the limit current value Iₜₕ may not be immediately avoidable.

Furthermore, in the ultraviolet-visible spectrophotometer 160, the voltage V applied to the photodetector 12 is lowered after the applied voltage V is maintained at a constant during the period T, and therefore, such a problem arises that the current value does not change during the period T even when a current that exceeds the limit current value Iₜₕ is outputted from the photodetector 12.

Thus, an open/close sensor is provided to the door 15a of the housing 15 that opens when the sample cell 6 or the reference cell 8 is replaced so that the applied voltage V is lowered before external light enters in order to prevent the photodetector 12 from deteriorating when the computer 130 detects the opening of the door 15a, that is to say, detects the entry of external light. In this case, the provision of the open/close sensor increases the cost. Furthermore, even when an open/close sensor is provided to the door 15a, the open/close sensor does not work when an attachment is used, and thus, such a problem arises that the entry of external light cannot be detected.

Thus, an object of the present invention is to detect the entry of external light when a sample cell is replaced by means of the output intensity signal obtained by the photodetector without providing an open/close sensor or the like to the door.

### Means for Solving Problem

In order to achieve the above-described object, the spectrophotometer according to the present invention is provided with: a sample cell; a light source unit for emitting light for measurement to the above-described sample cell; a photodetector for detecting light for measurement that has passed through the above-described sample cell; a light blocking unit for preventing light for measurement from the above-described light source unit from entering into the photodetector at a certain period; a storage unit for storing light blocking periods during which light is blocked by the above-described light blocking unit and output intensity signals obtained in the above-described photodetector by corresponding the periods to the signals; and a control unit for calculating transmittance or light absorbance on the basis of the output intensity signals during the light blocking periods and the output intensity signals during the light entry periods that are stored in the above-described storage unit, wherein the above-described storage unit stores a threshold for detecting the entry of external light into the above-described photodetector, and the above-described control unit detects the entry of external light into the above-described photodetector on the basis of the output intensity signals during the above-described light blocking periods and the threshold.

At this time, the output intensity signals during the light entry periods include light emitted from the light source in the apparatus while the output intensity signals during the light blocking periods do not include light emitted from the light source in the apparatus, but only include light from the outside of the apparatus, and therefore, all the output intensity signals during the light blocking periods can be regarded as coming from external light.

Here, the photodetector has the potential to deteriorate when an excessive amount of light enters or an excessive amount of current is outputted, and examples of this include a photomultiplier tube where the detection sensitivity is variable in accordance with the voltage V applied from the outside and a PbS photoconductive element.

In the spectrophotometer according to the present invention, the threshold I_{O} for detecting the entry of external light into the photodetector is stored. Thus, the control unit detects the entry of external light into the photodetector on the basis of the output intensity signals during the light blocking periods and the threshold I_{O}. As a result, for example, the voltage V applied to the photodetector can be drastically lowered instead of lowering the applied voltage V in such a manner that the output intensity signals change from the conversion limit value to the reference threshold I_{b}, the voltage V applied to the photodetector can be quickly lowered instead of maintaining the applied voltage V at a constant during the period T, or a light blocking shutter can be placed in front of the photodetector.

### Effects of the Invention

As described above, the spectrophotometer according to the present invention can detect the entry of external light when a sample cell is replaced on the basis of the output intensity signals during the light blocking periods even when no open/close sensor is provided to the door or an attachment is used.

(Other Means for Achieving Object and Their Effects)

The above-described invention may further be provided with a light blocking shutter that makes it impossible for external light to enter into the photodetector, where the above-described control unit may control the above-described light blocking shutter on the basis of the output intensity signals during the above-described light blocking periods and the threshold so that external light does not enter into the above-described photodetector.

In accordance with the spectrophotometer according to the present invention, the entry of external light when the sample cell is replaced can be detected so that an excessive amount of light can be prevented from entering into the photodetector when the sample cell is replaced.

In addition, the above-described invention may further be provided with a voltage generating unit for applying a voltage to the above-described photodetector, where the detection sensitivity of the above-described photodetector may be variable in accordance with the voltage applied from the outside, the above-described storage unit may store the voltage applied to the above-described photodetector, the light blocking periods during which light is blocked by the above-described light blocking unit, and the output intensity signals obtained by the above-described photodetector by corresponding the periods to the signals, the above-described control unit may calculate transmittance or light absorbance on the basis of the output intensity signals during the light blocking periods and the output intensity signals during the light entry periods that are stored in the above-described storage unit, and the voltage generating unit may be controlled on the basis of the above-described applied voltage, the output intensity signals during the light blocking periods and the threshold so that the above-described applied voltage is adjusted.

Furthermore, the above-described invention may further be provided with: a reference cell; and a switching unit that makes switching possible so that light for measurement is guided to the reference cell at a certain period instead of the above-described sample cell, where the above-described storage unit may store the light blocking periods during which light is blocked by the above-described light blocking unit, the switching periods during which the light path is switched by the above-described switching unit, and the output intensity signals obtained by the above-described photodetector by corresponding the periods to the signals, the above-described control unit may calculate transmittance or light absorption on the basis of the output intensity signals during the sample side light blocking periods, the output intensity signals during the sample side light entry periods, the output intensity signals during the reference side light blocking periods and the output intensity signals during the reference side light entry periods that are stored in the above-described storage unit, and the entry of external light into the above-described photodetector may be detected on the basis of the output intensity signals during the above-described sample side light blocking periods, the output intensity signals during the reference side light blocking periods and the threshold.

### BRIEF DESCRIPTION OF THE DRAWINGS

FIG. 1 is a schematic diagram showing the structure of the double-beam type ultraviolet-visible spectrophotometer according to one embodiment of the present invention;

FIG. 2 is a timing chart for a period during which the sector mirror rotates once;

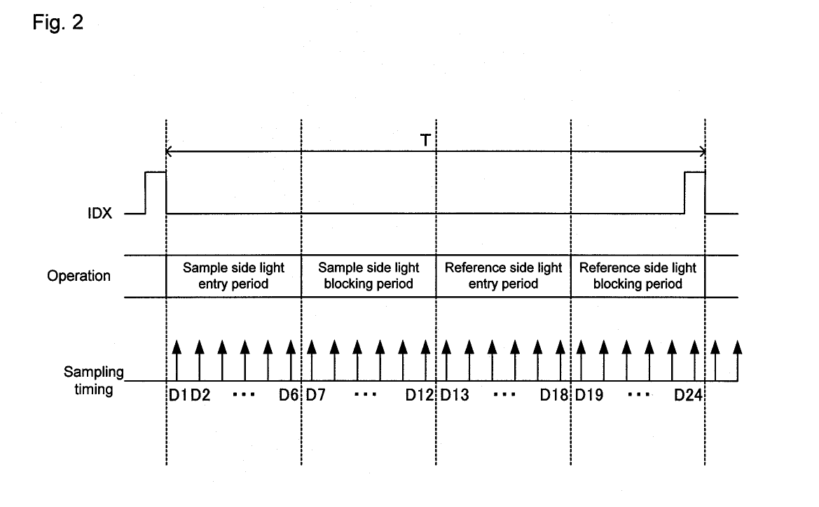

FIGS. 3(a) and 3(b) are charts showing an example of the relationship between the signal values and time over a number of periods;

FIG. 4 is a flow chart for illustrating the control method for controlling the voltage generating unit;

FIG. 5 is a schematic diagram showing the structure of a conventional double-beam type ultraviolet-visible spectrophotometer; and

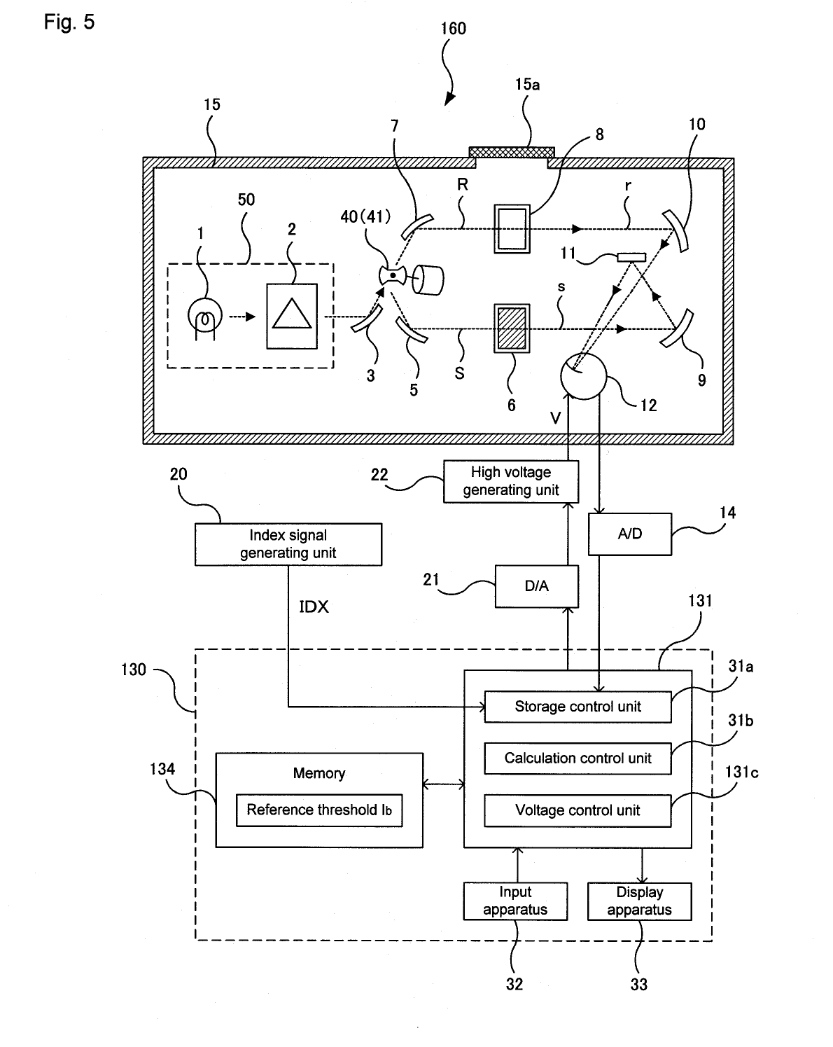

FIGS. 6(a) and 6(b) are charts showing an example of the relationship between the signal values and time over a number of periods.

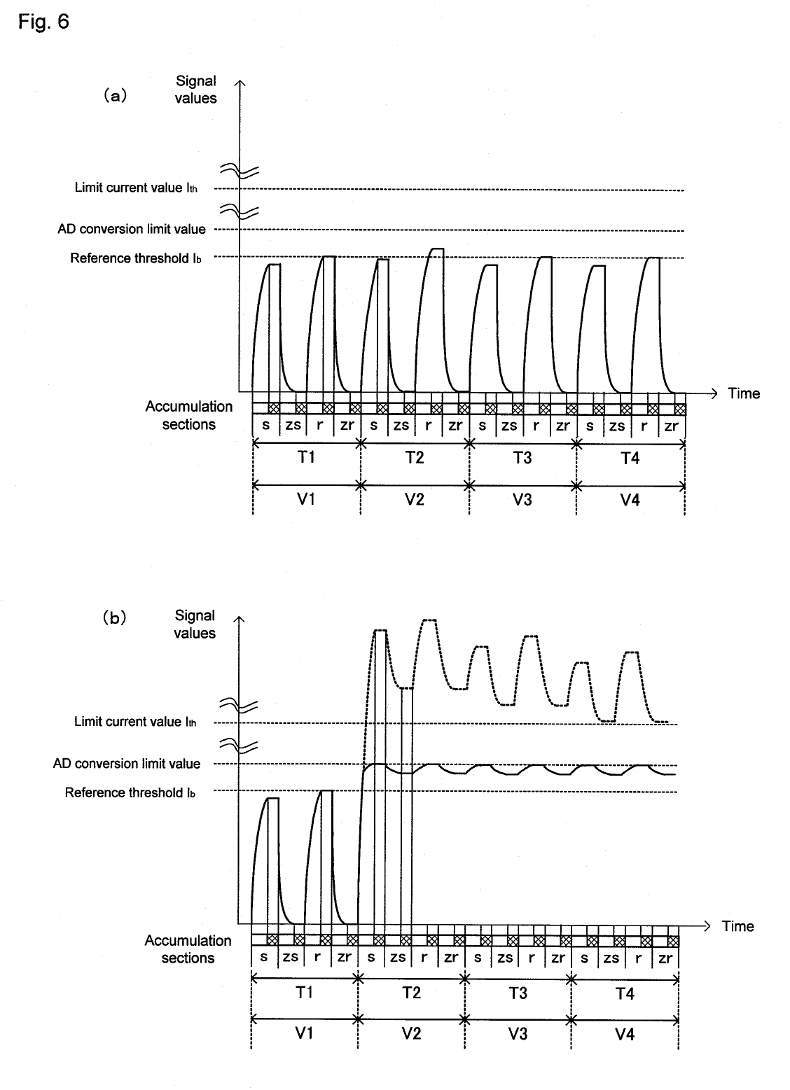

### DESCRIPTION OF THE PREFERRED EMBODIMENTS

In the following, the embodiments of the present invention are described in reference to the drawings. Here, the present invention is not limited to the below-described embodiments but includes various modifications as long as the gist of the present invention is not deviated from.

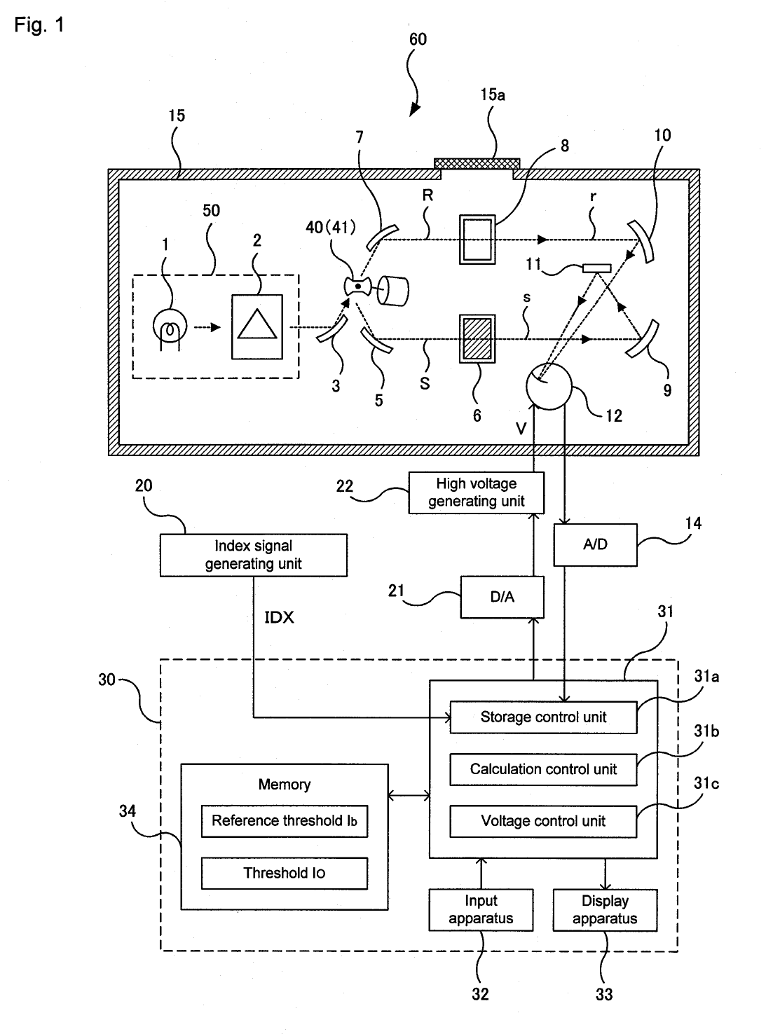

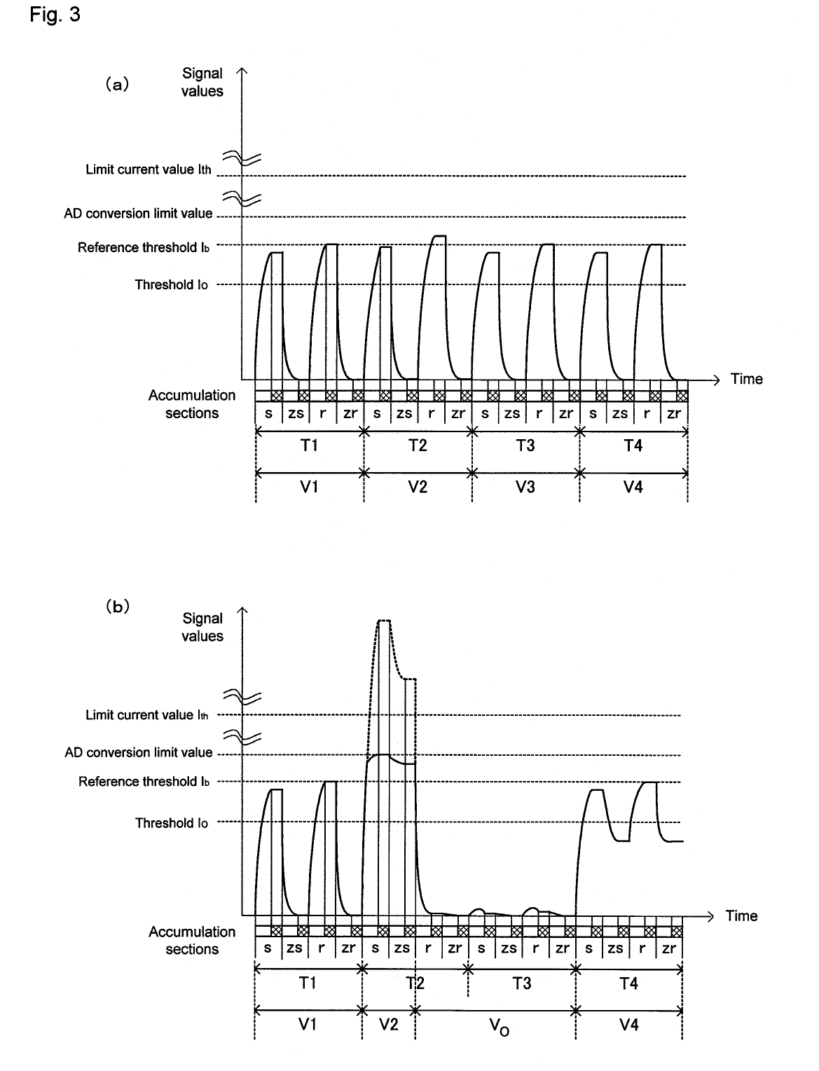

FIG. 1 is a schematic diagram showing the structure of the double-beam type ultraviolet-visible spectrophotometer according to one embodiment of the present invention. FIGS. 3(a) and 3(b) are diagrams showing an example of the relationship between the signal values and time over a number of periods. Here, the same symbols are attached to the same components as in the ultraviolet-visible spectrophotometer 160.

The ultraviolet-visible spectrophotometer 60 is provided with a sample cell 6, a reference cell 8, a light source unit 50 having a light source 1 for emitting light for measurement and a spectrometer 2, a photodetector 12, a sector mirror (switching unit, light blocking unit) 40, a number of reflective mirrors 3, 5, 7, 9, 10 and 11, a housing through which light does not transmit, a high voltage generating unit 22 for applying a voltage V to the photodetector 12, an index signal generating unit 20, an analog-digital (A/D) converter 14, a digital-analog (D/A) converter 21 and a computer 30 for controlling the entirety of the ultraviolet-visible spectrophotometer 60.

Here, the door 15a of the housing 15 in the present invention is not provided with an open/close sensor. That is to say, the cost can be reduced.

The computer 30 is provided with a CPU (control unit) 31 and a memory (storage unit) 34, and furthermore, an input apparatus 32 having a keyboard and a mouse and a display apparatus 33 are connected to the computer 30. In addition, the processes by the CPU 31 can be separated into blocks for description depending on the functions. The blocks are a storage control unit 31a for storing signal values (output intensity signals) from the photodetector 12 in the memory 34, a calculation control unit 31b for calculating the transmittance, and a voltage control unit 31c for controlling the high voltage generating unit 20.

Here, in the memory 34, the reference threshold I_{b} is stored in advance, and at the same time, the threshold I_{O} for detecting the entry of external light into the photodetector 12 is stored in advance.

The voltage control unit 31c carries out feedback control so as to determine the voltage V to be applied to the photodetector 12 in accordance with the signal values (sample side dark signal zₛ, sample side beam signal s, reference side dark signal zᵣ, reference side beam signal r) obtained by the photodetector (photomultiplier tube) 12, output an indication signal to the high voltage generating unit 22 in order to apply the determined voltage V, and adjust the detection sensitivity (amplification factor).

Typically, the voltage control unit 31c compares the signal value obtained by the photodetector 12 to the reference threshold I_{b} and lowers the voltage V applied to the photodetector 12 when the signal value exceeds the reference threshold I_{b} so as to lower the detection sensitivity, and thus reduces the current outputted from the photodetector 12. Meanwhile, the voltage control unit 31c increases the voltage V applied to the photodetector 12 when the signal value is less than the reference threshold I_{b} so as to increase the detection sensitivity, and thus increases the current outputted from the photodetector 12. That is to say, control is carried out so that the signal value (sample side beam signal s, reference side beam signal r) becomes the reference threshold I_{b}.

At this time, the voltage V applied to the photodetector 12 is maintained at a constant during one period T. That is to say, after period T1 has been completed, the voltage control unit 31c determines the voltage V2 to be applied during the next period T2 so that the voltage V applied to the photodetector 12 is changed from the voltage V1 to the voltage V2.

In addition, the voltage control unit 31c according to the present invention outputs an indication signal to the voltage generating unit 22 so as to drastically lower the applied voltage V (for example, the applied voltage V_{O} becomes 0) when the sample side dark signal zₛ (output intensity signal during the sample side light blocking period) and the sample side dark signal zᵣ (output intensity signal during the reference side light blocking period) are the same as the threshold I_{O} or greater, and thus carries out such control as to adjust the detection sensitivity (amplification factor).

Typically, as shown in FIG. 3(b), the voltage control unit 31c calculates the average value of the sample side dark signal zₛ for six pieces of detection value data corresponding to the sample side dark signal zₛ, compares the calculated sample side dark signal zₛ with the threshold I_{O}, and drastically lowers the voltage V applied to the photodetector 12 when the calculated sample side dark signal zₛ exceeds the threshold I_{O} so as to lower the detection sensitivity, and thus reduce the current outputted from the photodetector 12. That is to say, unlike the feedback control, there is no adjustment where the signal values become the reference threshold I_{b}.

Furthermore, the voltage V applied to the photodetector 12 is not maintained at a constant during the period T, but rather is changed immediately. That is to say, the voltage V applied to the photodetector 12 is changed from the voltage V1 applied during the sample side light blocking period T2 to the voltage V_{O} applied during the reference side light entry period T2 without waiting for the period T1 to be completed.

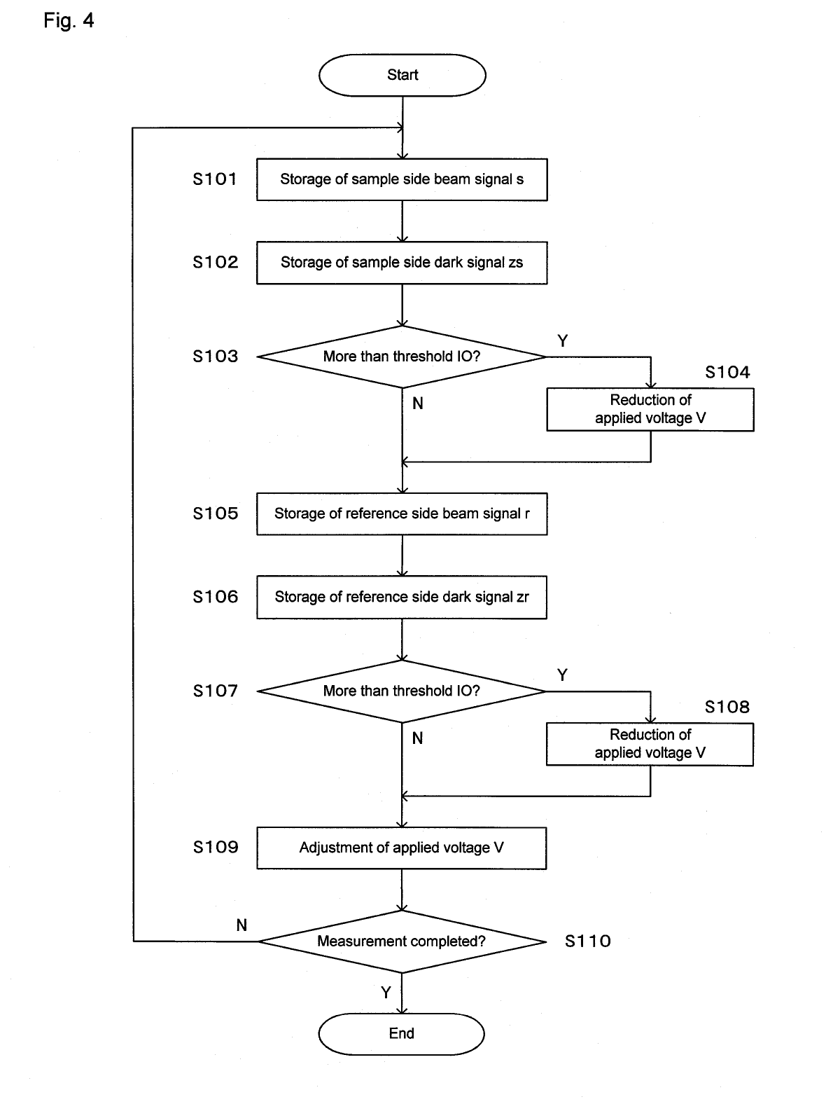

Here, one example of the control method according to which the voltage control unit 31c controls the high voltage generating unit 22 is described. FIG. 4 is a flow chart for illustrating the control method for controlling the high voltage generating unit 22.

First, in the process in step S101, the storage control unit 31a stores the sample side beam signal s from the photodetector 12 in the memory 34.

Next, in the process in step S102, the storage control unit 31a stores the sample side dark signal zₛ from the photodetector 12 in the memory 34.

Next, in the process in step S103, the voltage control unit 31c determines whether or not the sample side dark signal zₛ is the same as the threshold I_{O} or greater. When it is determined that the sample side dark signal zₛ is the same as the threshold I_{O} or greater, an indication signal is outputted to the high voltage generating unit 22 so that the applied voltage V is drastically lowered in the process in step S104.

Meanwhile, when it is determined that the sample side dark signal zₛ is less than the threshold I_{O}, the storage control unit 31a stores the reference side beam signal r from the photodetector 12 in the memory 34 in the process in step S105.

Next, in the process in step S106, the storage control unit 31a stores the reference side dark signal zᵣ from the photodetector 12 in the memory 34.

Next, in the process in step S107, the voltage control unit 31c determines whether or not the reference side dark signal zᵣ is the same as the threshold I_{O} or greater. When it is determined that the reference side dark signal zᵣ is the same as the threshold I_{O} or greater, an indication signal is outputted to the high voltage generating unit 22 so that the applied voltage V is drastically lowered in the process in step S108.

Meanwhile, in the case where it is determined that the reference side dark signal zᵣ is less than the threshold I_{O}, the voltage control unit 31c compares the sample side beam signal s and the reference side beam signal r with the reference threshold I_{b} and outputs an indication signal to the high voltage generating unit 22 so that the applied voltage V is adjusted in the process in step S109.

Next, in the process in step S110, it is determined whether or not the measurement has been completed. When it is determined that the measurement has not been completed, the procedure returns to the process in step S101.

Meanwhile, when it is determined that the measurement has been completed, the present flow chart is completed.

As described above, in the ultraviolet-visible spectrophotometer 60, the entry of external light can be detected on the basis of the reference side dark signal zᵣ and the sample side dark signal zₛ when the sample cell 6 or the reference cell 8 is replaced without an open/close sensor being provided to the door 15a of the housing 15 when an attachment is used. As a result, an excessive current that could deteriorate the photodetector 12 can be prevented from flowing through the photodetector 12 when the sample cell 6 or the reference cell 8 is replaced. Here, the sample cell 6 or the reference cell 8 is not replaced while the sample is being measured, and therefore, the output intensity signal during the light blocking period does not exceed the threshold I_{O}, and therefore, the applied voltage V can be maintained at a constant during the period T. That is to say, the computer 30 can precisely calculate the transmittance.

### Other Embodiments

(1) Though the above-described ultraviolet-visible spectrophotometer 60 has such a structure that the photodetector 12 includes a photomultiplier tube for detecting ultraviolet rays, the structure may include a PbS photoconductive element for detecting infrared rays. At this time, a light blocking shutter that can prevent external light from entering into the photodetector is provided, and the control unit controls the light blocking shutter so that external light can be prevented from entering into the photodetector for a predetermined period of time (for example, one second) when it is determined that the sample side dark signal zₛ (output intensity signal during the sample side light blocking period) and the reference side dark signal zᵣ (output intensity signal during the reference side light blocking period) are the same as the threshold I_{O} or greater. Alternatively, the light blocking shutter may be released manually.

(2) Though the above-described ultraviolet⁻visible spectrophotometer 60 has such a structure that an indication signal is outputted to the voltage generating unit 22 so as to drastically lower the applied voltage V (for example, the applied voltage V_{O} becomes 0) when the sample side dark signal zₛ and the reference side dark signal zᵣ are the same as the threshold I_{O} or greater, the structure may allow an indication signal to be outputted to the voltage generating unit so that the applied voltage V_{O} becomes 0 to −50 V, for example.

(3) Though the above-described ultraviolet-visible spectrophotometer 60 has such a structure that the voltage V applied to the photodetector 12 is not maintained at a constant during the period T, but rather is changed immediately when the sample side dark signal zₛ and the reference side dark signal zᵣ are the same as the threshold I_{O} or greater, the structure may allow the voltage V applied to the photodetector to be changed after being maintained at a constant during the period T.

### INDUSTRIAL APPLICABILITY

The present invention can be applied to a photomultiplier tube where the detection sensitivity is variable in accordance with the voltage applied from the outside, and a spectrophotometer using a photodetector, such as a PbS photoconductive element, for example.

### Explanation of Symbols

6 sample cell

12 photodetector

22 high voltage generating unit

31b calculation control unit

31c voltage control unit

34 memory (storage unit)

41 light blocking unit

50 light source unit

60 ultraviolet-visible spectrophotometer

1-6. (canceled)

7. A spectrophotometer, comprising:
a sample cell;
a light source unit for emitting light for measurement to said sample cell;
a photodetector for detecting light for measurement that has passed through said sample cell;
a light blocking unit for preventing light for measurement from said light source unit from entering into the photodetector at a certain period; and
a storage unit for storing output intensity signals obtained in said photodetector by corresponding the signals to light entry periods or light blocking periods during which light is blocked by said light blocking unit, characterized in that
said storage unit stores a threshold for detecting the entry of external light into said photodetector, and
the spectrophotometer further comprises a control unit for detecting the entry of external light into said photodetector on the basis of the output intensity signals that are stored in said storage unit and corresponded to said light blocking periods as well as said threshold.

8. The spectrophotometer according to claim 7, further comprising a light blocking shutter that makes it impossible for external light to enter into the photodetector, characterized in that said control unit controls said light blocking shutter on the basis of the output intensity signals during said light blocking periods and the threshold so that external light does not enter into said photodetector.

9. The spectrophotometer according to claim 7, further comprising a voltage generating unit for applying a voltage to said photodetector, characterized in that
the detection sensitivity of said photodetector is variable in accordance with the applied voltage, and
said control unit controls the voltage generating unit so that said applied voltage is adjusted on the basis of the output intensity signals corresponded to said light blocking periods as well as said threshold.

10. The spectrophotometer according to claim 7, further comprising:
a reference cell; and
a switching unit that makes switching possible so that light for measurement is guided to the sample cell or the reference cell at a certain period, characterized in that
said storage unit stores the output intensity signals obtained in said spectrophotometer by corresponding the signals to the light blocking periods during which light is blocked by said light blocking unit and the switching periods during which the light path is switched to the sample cell or the reference cell by said switching unit, and
said control unit detects the entry of external light into said photodetector on the basis of the output intensity signals corresponded to said sample side light blocking periods, the output intensity signals corresponded to the reference side light blocking periods, and said threshold.

11. The spectrophotometer according to claim 8, further comprising:
a reference cell; and
a switching unit that makes switching possible so that light for measurement is guided to the sample cell or the reference cell at a certain period, characterized in that
said storage unit stores the output intensity signals obtained in said spectrophotometer by corresponding the signals to the light blocking periods during which light is blocked by said light blocking unit and the switching periods during which the light path is switched to the sample cell or the reference cell by said switching unit, and
said control unit detects the entry of external light into said photodetector on the basis of the output intensity signals corresponded to said sample side light blocking periods, the output intensity signals corresponded to the reference side light blocking periods, and said threshold.

12. The spectrophotometer according to claim 9, further comprising:
a reference cell; and
a switching unit that makes switching possible so that light for measurement is guided to the sample cell or the reference cell at a certain period, characterized in that
said storage unit stores the output intensity signals obtained in said spectrophotometer by corresponding the signals to the light blocking periods during which light is blocked by said light blocking unit and the switching periods during which the light path is switched to the sample cell or the reference cell by said switching unit, and
said control unit detects the entry of external light into said photodetector on the basis of the output intensity signals corresponded to said sample side light blocking periods, the output intensity signals corresponded to the reference side light blocking periods, and said threshold.
